(19) United States
(12) Patent Application Publication
(10) Pub. No.: US 2017/0117738 A1
(43) Pub. Date: Apr. 27, 2017

(54) WIRELESS CHARGING MAT AS A BATTERY CHARGING INDICATOR

(71) Applicant: MOTOROLA SOLUTIONS, INC., Schaumburg, IL (US)

(72) Inventors: Chen Kok Yeoh, Bukit Mertajam (MY); William B. Kiger, Hoschton, GA (US); Macwien Krishnamurthi, Shah Alam (MY); Chin Wun Ng, Ipoh (MY); Cheah Heng Tan, Bayan Lepas (MY); Mun Yew Tham, Bayan Lepas (MY)

(21) Appl. No.: 14/922,559

(22) Filed: Oct. 26, 2015

(51) Int. Cl. H02J 7/02

(52) U.S. Cl. CPC H02J 7/025; H02J 7/027; H02J 2007/0096

(57) ABSTRACT

A method and apparatus for visually indicating battery pack information related to wirelessly charging a battery pack via a wireless charging mat. The method includes uniquely associating, with a controller of the wireless charging mat, each visual indicator of a first plurality of visual indicators on the wireless charging mat with one of a first plurality of sensors on the wireless charging mat. The method further includes receiving the battery pack information from the battery pack with one or more of the first plurality of sensors. The method further includes wirelessly charging the battery pack using the wireless charging mat, and illuminating the first plurality of visual indicators based on the battery pack information.

### BACKGROUND OF THE INVENTION

Electronic and other devices powered by batteries are in widespread use. Commonly available devices include, for example, mobile radios, cellular telephones, global positioning satellite (GPS) navigation systems, tablet computers, laptop computers, and wireless headsets. The portability offered by battery-powered devices is advantageous in many ways. However, a drawback of battery-powered devices is the need to recharge the battery, as every battery or battery pack has a limited storage capability.

Multi-unit chargers have been developed to simultaneously charge multiple battery packs, reducing the total time to charge a plurality of battery packs. Some conventional multi-unit chargers include electro-mechanical connections between the charger and each battery pack to be charged. Some multi-unit chargers have been developed to charge each battery pack wirelessly, for example, wireless charging mats. However, when a wireless multi-unit charger is used, it is often difficult to determine the charging status of the many battery packs being charged. Often, the only way to determine battery charge of an individual battery is to connect or install a battery pack to a particular device as devices often include a charge indicator.

Accordingly, there is a need for an improved battery charging indicator.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a wireless battery charging system in accordance with some embodiments.

FIG. 2 illustrates a block diagram of the wireless charging system of FIG. 1.

FIGS. 3A is a side view of a wireless charging system in accordance with some embodiments.

FIG. 3B is a top view of a wireless charging system in accordance with some embodiments.

FIGS. 4A and 4B illustrate a wireless charging mat in accordance with some embodiments.

FIGS. 5 through 7 are flowcharts of a method for indicating battery pack information about battery packs that are being charged on the wireless charging mat of FIGS. 4A and 4B.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Embodiments of the invention include a method of visually indicating battery pack information related to wirelessly charging a battery pack via a wireless charging mat. In one exemplary embodiment, the method includes uniquely associating, with a controller of the wireless charging mat, each visual indicator of a first plurality of visual indicators on the wireless charging mat with one of a first plurality of sensors on the wireless charging mat. The method further includes receiving the battery pack information from the battery pack with one or more of the first plurality of sensors. The method further includes wirelessly charging the battery pack using the wireless charging mat, and illuminating the first plurality of visual indicators based on the battery pack information.

Some embodiments include a system for visually indicating battery pack information related to wirelessly charging a battery pack. In one embodiment, the system includes a wireless charging mat including a power supply and a plurality of charging coils. Each of the plurality of charging coils is coupled to the power supply and configured to wirelessly charge the battery pack using power received via the power supply. The wireless charging mat further includes a first plurality of sensors, a first plurality of visual indicators, and a controller. Each of the first plurality of sensors is configured to receive the battery pack information from the battery pack. Each of the first plurality of visual indicators is uniquely associated with one of the first plurality of sensors. The controller illuminates the first plurality of visual indicators based on the battery pack information.

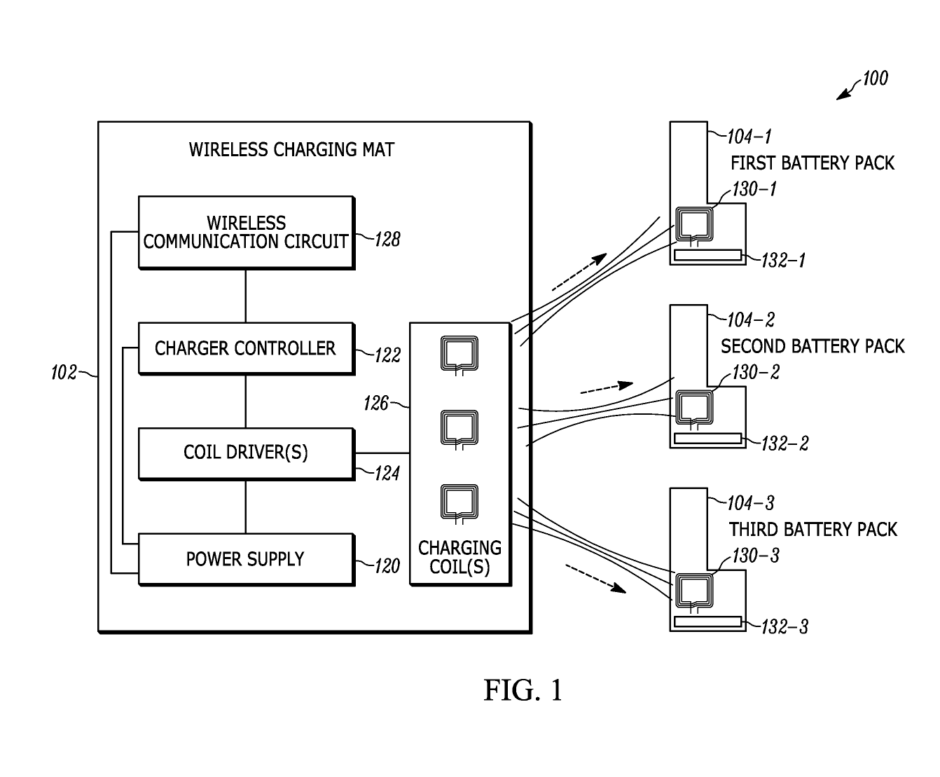

FIG. 1 illustrates a wireless charging system 100. In the example illustrated, the system 100 includes a wireless charging mat 102, a first battery pack 104-1, a second battery pack 104-2, and a third battery pack 104-3. The first battery pack 104-1, second battery pack 104-2, and third battery pack 104-3 may be generically referred to as battery packs 104. It will be appreciated that a different number of battery packs could be included in other embodiments. The wireless charging mat 102 is a charger that charges one or more of the battery packs 104 via induction, without an electro-mechanical connection between the battery packs 104 and the wireless charging mat 102. The battery packs 104 may be of different types having one or more of different power output levels, capacities, physical and electrical interfaces, and housing configurations, among other variations. Accordingly, the wireless charging mat 102 may be referred to as a “universal” charger. Alternatively, in some embodiments, some or all of the battery packs 104 could be of the same type.

Each battery pack 104 is able to be coupled to and provide power to a battery powered device (not pictured). The battery powered device may be, for instance, a two-way radio. In other embodiments, the battery powered device is a smart telephone, tablet computer, laptop computer, or other battery powered device having rechargeable battery packs. The wireless charging mat 102 is further configured to wirelessly charge the battery pack 104 while the battery pack 104 is installed in the battery powered device. In other words, the battery pack 104 may be, but does not need to be, removed from the battery powered device to be charged by the wireless charging mat 102.

The wireless charging mat 102 includes a power supply 120, a charger controller 122, coil drivers 124, charging coils 126, and a wireless communication circuit 128. The power supply 120 includes, for instance, appropriate conversion and conditioning circuitry and an input (not shown) to connect the wireless charging mat 102 to an external power source, such as a standard wall outlet (e.g., at 120 volts, 60 hertz), a photovoltaic cell, an internal-combustion-engine driven, electric power generator, a twelve (12) volt (vehicle) battery, or another source. The conditioning circuitry may, for example, condition received power from the external source to levels adequate for usage by other components of the wireless charging mat 102. For instance, in some embodiments, the power supply 120 includes a rectifier to convert alternating current (AC) power received from a standard wall outlet to direct current (DC) power for supply to various components within the wireless charging mat 102, including the charger controller 122, coil drivers 124, charging coils 126, and wireless communication circuit 128.

The first battery pack 104-1 includes a first recipient coil 130-1 and one or more first battery cells 132-1. The second battery pack 104-2 includes a second recipient coil 130-2 and one or more second battery cells 132-2. The third battery pack 104-3 includes a third recipient coil 130-3 and one or more third battery cells 132-3. The recipient coils 130-1, 130-2, and 130-3 are generically referred to as the recipient coils 130 and the battery cells 132-1, 132-2, and 132-3 are generically referred to as the battery cells 132.

The charger controller 122 controls components of the wireless charging mat 102 to charge the battery packs 104. More particularly, to charge the battery packs 104, the charger controller 122 selectively controls the coil drivers 124 to drive the charging coils 126 using power received from the power supply 120. The coil drivers 124 may include power transistors, such as field effect transistors, selectively enabled and disabled by the charger controller 122 to provide an alternating or time-varying current. Driving the charging coils 126 includes providing the time-varying electric current generated by the coil drivers 124 to the charging coils 126. The time-varying electric current within each of the charging coils 126 produces a changing magnetic field.

The changing magnetic field of each charging coil 126 is received by the recipient coil 130 of each of the battery packs 104, which induces a time-varying electric current within the recipient coils 130. This time-varying electric current induced in the recipient coils 130 may be referred to as charging current. The charging current is received, conditioned, and applied to one or more battery cells 132 within the battery packs 104 to charge the battery packs 104. Accordingly, power is wirelessly transferred from charging coils 126 to the recipient coils 130. This transfer results in the wireless charging of the battery packs 104.

In the illustrated embodiment, the wireless charging mat 102 includes one charging coil 126 for each battery pack 104. Such a configuration permits the wireless charging mat 102 to charge the battery packs 104 simultaneously. Accordingly, as illustrated in FIG. 1, the wireless charging mat 102 is configured to simultaneously charge three battery packs 104. In other embodiments, more or fewer charging coils 126 are provided within the wireless charging mat 102 such that more or fewer battery packs 104 may be simultaneously charged by the wireless charging mat 102. As described in further detail below, the charging coils 126 may be selectively driven such that none, one, some, or all of the charging coils 126 are driven at a given moment in time.

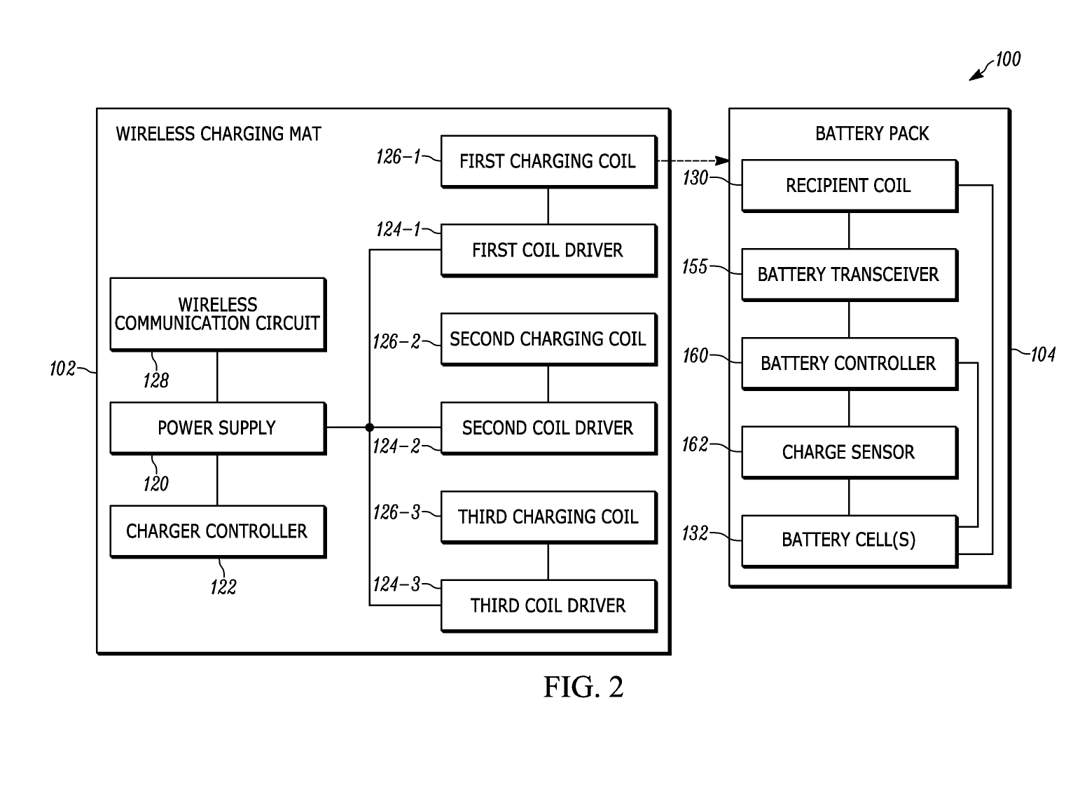

FIG. 2 is a block diagram of the wireless charging system 100 and provides greater detail of certain aspects of the wireless charging system 100. In FIG. 2, the battery pack 104 includes a battery transceiver 155, a battery controller 160, and a charge sensor 162. The wireless communication circuit 128 (explained in greater detail below) of the wireless charging mat 102 forms a communication link with the battery transceiver 155 of the battery pack 104. The communication link enables communications between the charger controller 122 and the battery controller 160. The communications between the charger controller 122 and the battery controller 160 may be bidirectional or unidirectional.

The battery transceiver 155 of the battery pack 104 is powered by power obtained via the recipient coil 130. Accordingly, the battery transceiver 155 does not drain power from the battery cells 132. In other embodiments, however, the battery transceiver 155 is powered in part or entirely by the battery cells 132. The battery controller 160 is coupled to and powered by the battery cells 132. The battery cells 132 may include one or more battery cells, such as lithium ion cells or cells of another cell chemistry type. The battery controller 160 is further coupled to and communicates with the charge sensor 162. The charge sensor 162 provides an indication of the state of charge (i.e., charge level) of the battery cells 132 to the battery controller 160. For instance, the charge sensor 162 may include a voltage sensor that indicates the voltage level of the battery cells 132, from which the battery controller 160 may infer the state of charge of the battery cells 132.

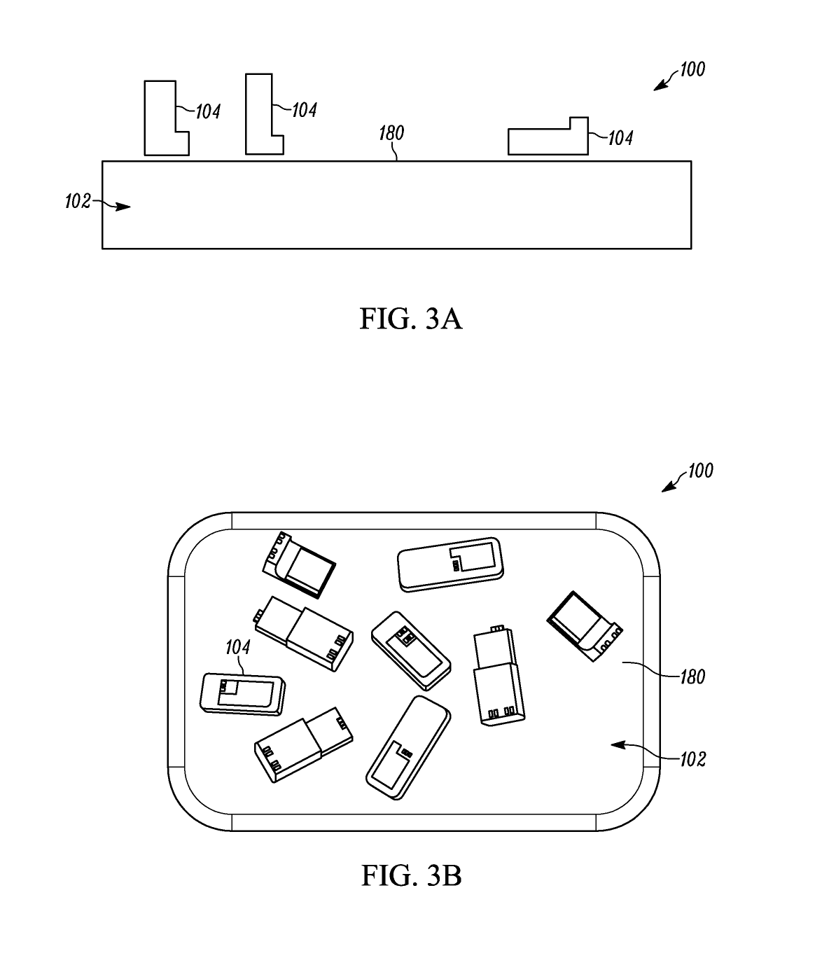

FIGS. 3A and 3B illustrate an embodiment of the wireless charging system 100. As shown in FIGS. 3A and 3B, the wireless charging system 100 includes a wireless charging mat 102 having a mat surface 180 that is generally planar and supports battery packs 104 thereon. In the wireless charging mat 102, the charging coils 126 are distributed in various locations below the mat surface 180. The charging coils 126 may overlap one another or be positioned such that the charging coils 126 do not overlap one another. The charging coils 126 are generally planar coils, although other coil shapes may be used in other embodiments. Each individual charging coil 126 is able to charge a separate battery pack 104. In some embodiments, the wireless charging mat 102 may not be generally planar. For example, the wireless charging mat 102 may be bowl-shaped. Alternatively, the mat surface 180 of the wireless charging mat 102 may vary (i.e., a wave-like surface).

In some embodiments, the wireless charging system 100 includes multiple wireless charging mats 102 (not shown). For example, multiple wireless charging mats 102 may be adjacently placed in parallel to each other (i.e., side by side). Battery packs 104 may be placed in between the wireless charging mats 102. The wireless charging mats 102 may have similar capabilities relating to wirelessly charging battery packs 104 and visually indicating battery pack information as the wireless charging mat 102 explained below. In some embodiments including multiple wireless charging mats 102, the wireless charging system 100 may include a first wireless charging mat 102 having a mat surface 180 that is generally planar and supports battery packs 104 thereon, as shown in FIGS. 3A and 3B. The wireless charging system 100 may also include a second wireless charging mat (not shown) located above, and substantially parallel to, the first wireless charging mat 102. The first and second wireless charging mats may have similar capabilities relating to wirelessly charging battery packs 104 and visually indicating battery pack information. One or both of the first wireless charging mat 102 and the second wireless charging mat may have at least one reflective surface such that the battery packs 104 placed in between the first wireless charging mat 102 and the second wireless charging mat could be observed.

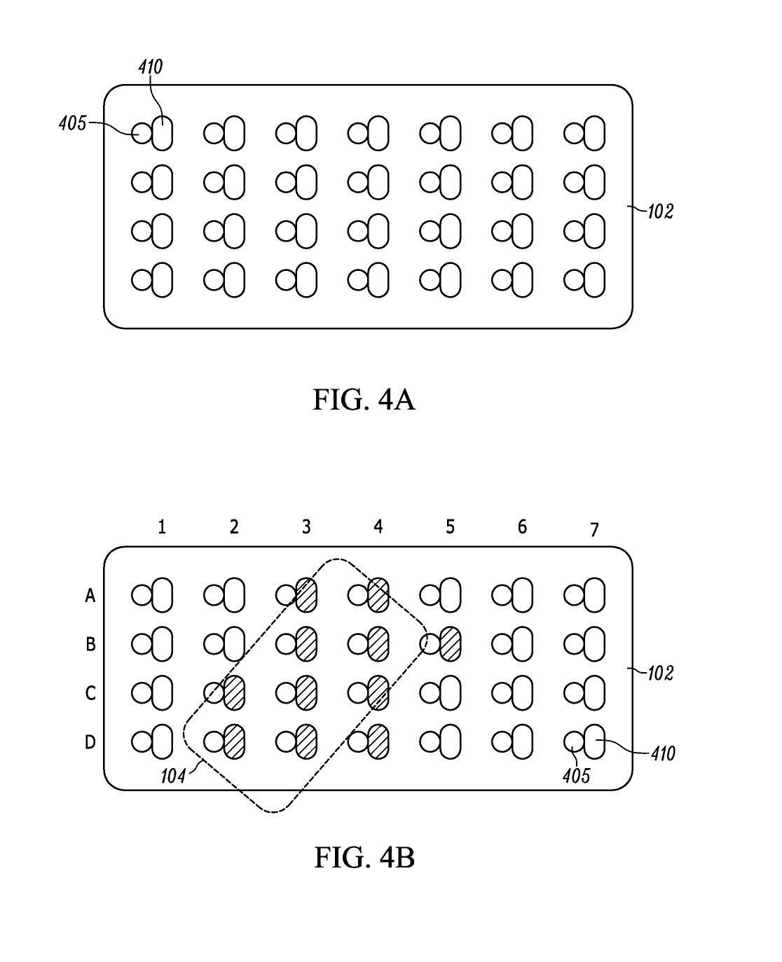

FIGS. 4A and 4B illustrate the wireless communication circuit 128 of the wireless charging mat 102 in further detail. In FIG. 4A, the wireless charging mat 102 includes wireless sensors 405 and visual indicators 410 arranged in pairs to form an array. The visual indicators 410 may be, for example, light emitting diodes (LEDs). Each visual indicator 410 is located in close proximity to and is uniquely associated with one wireless sensor 405. For example, in FIG. 4B, the visual indicator 410 located in row A, column 1 is located in close proximity to and is uniquely associated with the wireless sensor 405 located in row A, column 1 Accordingly, the visual indicator 410 located in row A, column 1, may be illuminated based on battery pack information sensed by the wireless sensor 405 located in row A, column 1.

The visual indicators 410 may be uniquely associated with corresponding wireless sensors 405 in multiple ways. For example, in some embodiments the visual indicators 410 may be uniquely associated with corresponding wireless sensors 405 based on hardware connections in the wireless charging mat 102. In other embodiments, the charger controller 122 may uniquely associate the visual indicators 410 with corresponding wireless sensors 405. When the visual indicators 410 are uniquely associated with the wireless sensors 405, the charger controller 122 illuminates each visual indicator 410 based on the input received by the corresponding uniquely associated wireless sensor 405. The wireless sensors 405 may include Bluetooth™ communication circuits that communicate according to the Bluetooth™ protocol. In other instances, the wireless communication circuit 128 and the battery transceiver 155 may include near field communication (NFC) circuits, Wi-Fi (i.e., IEEE 802.11x) communication circuits, or communication circuits for implementing another form of short-range wireless communications.

Furthermore, in some embodiments, the visual indicators 410 may be tri-color light emitting diodes (LEDs), other types of visual indicators, or groups of visual indicators (i.e., multiple visual indicators 410 may be in close proximity with each wireless sensor 405 and form one element of the array). Furthermore, the particular array of FIG. 4A is exemplary. In some embodiments, the wireless charging mat 102 includes more or less elements in the array.

FIG. 4B illustrates a charging scenario with a battery pack 104 placed on the wireless charging mat 102. In FIG. 4B, the rows and columns of the array of wireless sensors 405 and visual indicators 410 are labeled such that each pair of elements within the array may be easily identified. An outline of the battery pack 104 is shown to allow the full array to be visible. As shown in FIG. 4B, a plurality of visual indicators 410 are illuminated based on battery pack information received by the corresponding wireless sensors 405 from the battery pack 104. In particular, the plurality of visual indicators 410 that are illuminated include A3, A4, B3, B4, B5, C2, C3, C4, D2, D3, and D4. The charger controller 122 illuminates each visual indicator 410 based on the battery pack information received by the wireless sensor 405 in which each visual indicator 410 is uniquely associated.

The battery pack information may include a charge level of the battery pack 104, a battery type, an owner identifier, charging statistics (i.e., number of times charged), or other information related to battery performance or status. In some embodiments, the charger controller 122 may control the visual indicators 410 to illuminate a certain color depending on charging status (i.e., green to indicate a fully charged battery and red to indicate a battery that is less than 50% charged). In other embodiments, the charger controller 122 may control the visual indicators 410 to illuminate intermittently at varying frequencies depending on charging status. In some embodiments, the charger controller 122 may control the visual indicators 410 to illuminate a certain color depending on the owner identifier (i.e., the area around user A's device is illuminated in one color while the area around user B's device is illuminated in another color).

Accordingly, the wireless charging mat 102 may illuminate or activate visual indicators 410 in a pattern that substantially outlines a predetermined shape of the battery pack 104 on the wireless charging mat 102. Alternatively, when the battery pack 104 is coupled to a battery powered device (not shown) and placed on the wireless charging mat 102, the wireless charging mat 102 may illuminate visual indicators 410 in a pattern that substantially outlines a predetermined shape of the battery powered device.

In other embodiments, the charger controller 122 may illuminate a second plurality of visual indicators 410 that are located within a predetermined distance from the first plurality of visual indicators 410. The second plurality of visual indicators 410 may be illuminated using the same battery pack information that was used to illuminate the first plurality of visual indicators 410. For example, in FIG. 4B, visual indicators A5, B2, C1, C5, and D1 may be illuminated in the same manner as visual indicators A3, A4, B3, B4, B5, C2, C3, C4, D2, D3, and D4. In some embodiments, both groups of visual indicators 410 may be controlled to have the same output even though the corresponding wireless sensors 405 of one of the groups did not receive battery pack information from the battery pack 104.

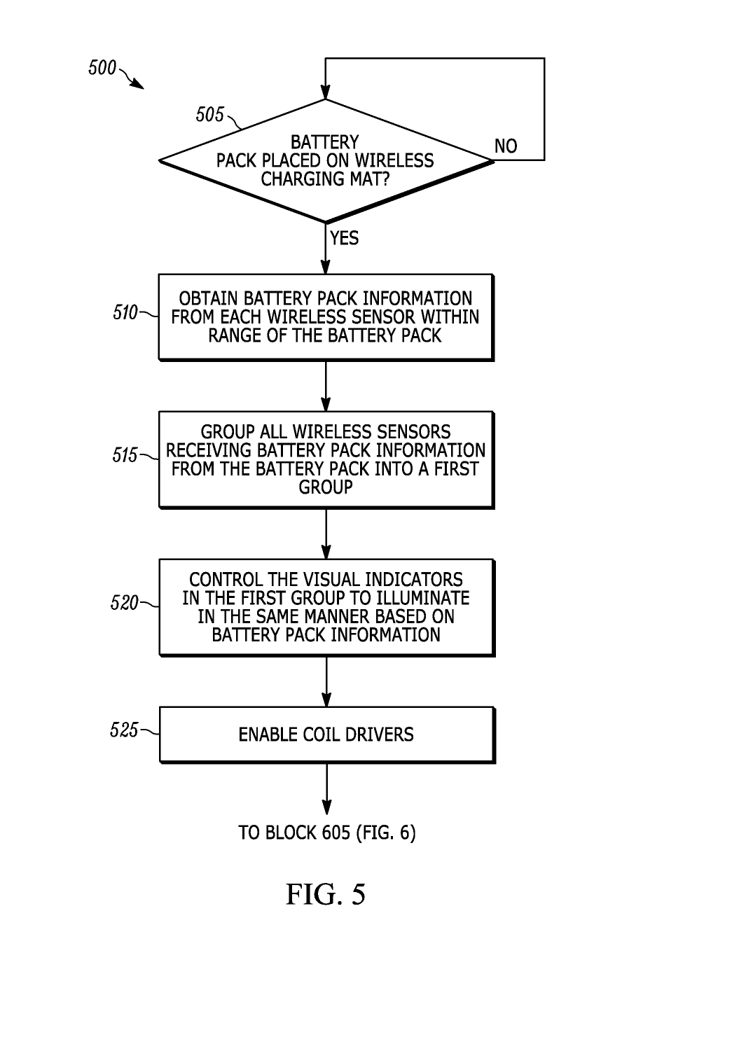

FIG. 5 illustrates a method 500 for indicating battery pack information about a plurality of battery packs 104 that are being charged on the wireless charging mat 102. At block 505, the wireless charging mat 102 and, more particularly, the charger controller 122, determines when a battery pack 104 is placed on the wireless charging mat 102. For instance, the charger controller 122 may detect the presence (and absence) of battery packs 104 based on detecting (and not detecting) broadcast messages or other communications from the battery packs 104 received via the wireless sensors 405. When there are no battery packs 104 placed on the wireless charging mat 102, the method 500 remains at block 505 and waits for a battery pack 104 to be placed on the wireless charging mat 102. When the battery pack 104 is placed on the wireless charging mat 102, at block 510, the charger controller 122 obtains battery pack information from each wireless sensor 405 within range of the battery pack 104.

The battery pack information may include a charge level of the battery pack 104, a battery type, an owner identifier, charging statistics (i.e., number of times charged), or other information related to battery performance or status. For instance, the charger controller 122 receives updated charge status information for each battery pack 104 on the wireless charging mat 102 based on data periodically pushed to the charger controller 122 by the battery pack 104 or in response to periodic requests from the charger controller 122. The charge status information indicates whether the associated battery pack 104 is fully charged, the current charge level of the battery pack 104, or both. The charge level may take the form of a relative charge value for the battery pack 104 (e.g., a percentage of charge capacity of the battery pack 104) or an absolute charge level (e.g., expressed as a coulomb count).

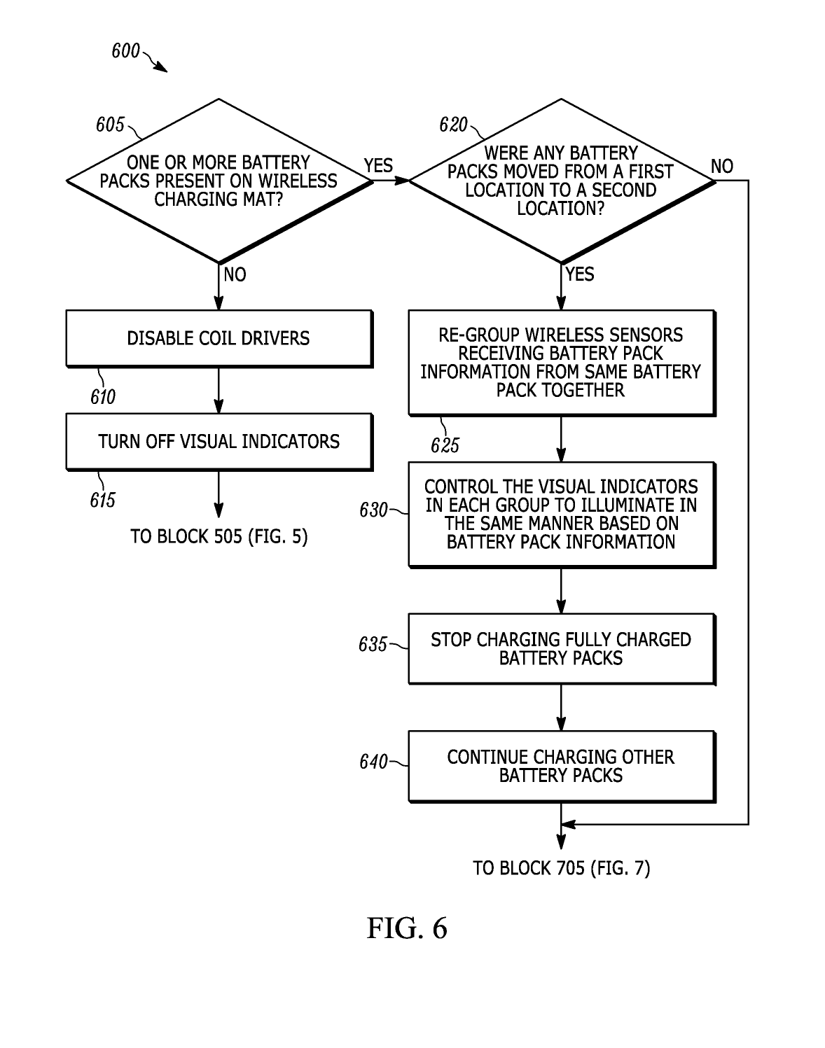

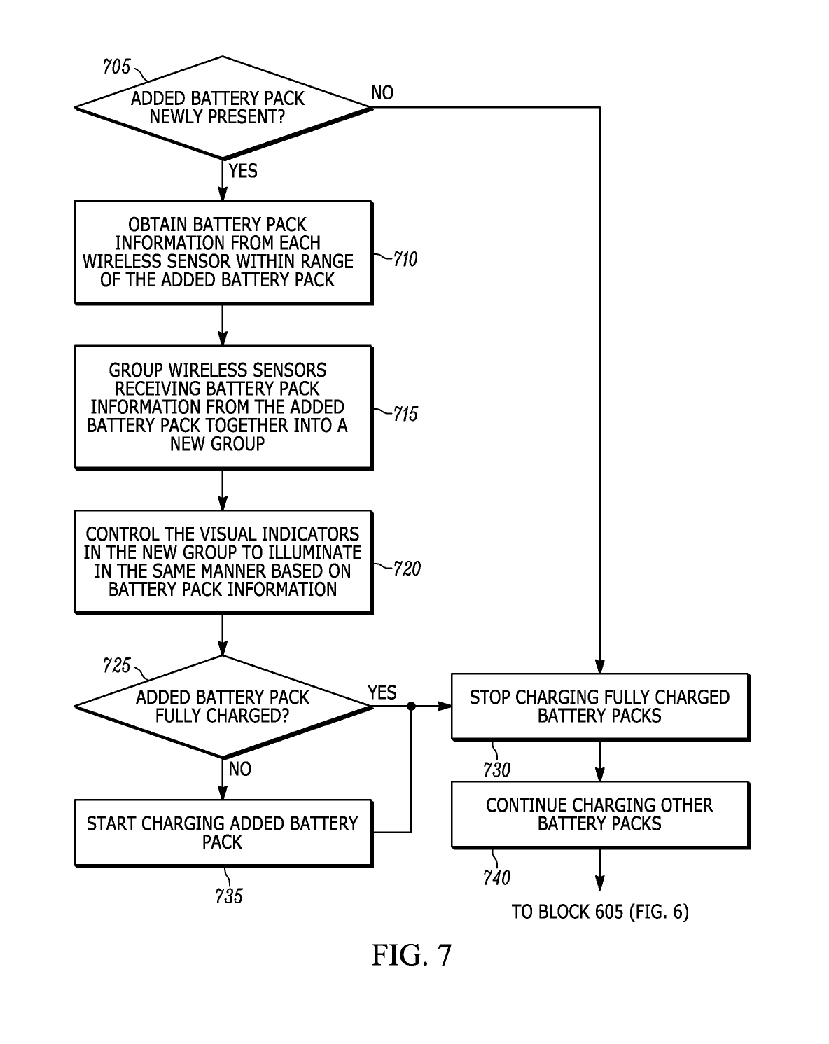

At block 515, the charger controller 122 groups all wireless sensors 405 that received battery pack information from the battery pack 104 into a first group. The first group includes a plurality of visual indicators 410 that each correspond to one of a plurality of wireless sensors 405. At block 520, the charger controller 122 controls the visual indicators 410 that correspond to the first group to illuminate in the same manner based on the battery pack information received from the battery pack 104, thereby visually indicating battery pack information about the battery pack 104 using the wireless charging mat 102. At block 525, the charger controller 122 enables the appropriate coil drivers 124 to drive charging coils 126 to wirelessly charge the battery pack 104. After the coil drivers 124 are enabled, the method 500 proceeds to block 605 (see FIG. 6) to monitor the wireless charging mat 102. When one or more battery packs 104 are present on the wireless charging mat 102, the wireless charging mat 102 may detect new battery packs 104 placed on the charging mat 102 as will be explained in greater detail below with respect to FIG. 7.

FIG. 6 illustrates an exemplary battery pack information indication method 600 for implementing on the wireless charging mat 102 while charging a plurality of battery packs 104. At block 605, the wireless charging mat 102 determines whether one or more battery packs 104 are still present on the wireless charging mat 102. When no battery packs 104 are present, the wireless charging mat 102 proceeds to block 610, where the charger controller 122 disables the coil drivers 124 to cease driving of the charging coils 126. At block 615, the charger controller 122 turns off the visual indicators 410 and the method 600 proceeds back to block 505 to wait for a battery pack 104 to be placed on the wireless charging mat 102.

When one or more battery packs 104 are present on the wireless charging mat 102, at block 620, the charger controller 122 detects whether any battery packs 104 were moved from a first location to a second location on the wireless charging mat 102. In some embodiments, the charger controller 122 accomplishes block 620 by reading the battery pack information received from all wireless sensors 405 and comparing it to previously-read battery pack information. When at least one wireless sensor 405 has received battery pack information from a different battery pack 104 than it had previously received battery pack information from, the charger controller 122 determines that at least one battery pack 104 was moved from a first location to the second location on the wireless charging mat 102. When a battery pack 104 has moved locations on the wireless charging mat 102, at block 625, the charger controller 122 re-groups the wireless sensors 405 receiving battery pack information from the same battery pack 104 together. Each group includes a plurality of visual indicators 410 that each correspond to one of a plurality of wireless sensors 405. In other embodiments, the method 600 may not include block 620. In such embodiments, the charger controller 122 may repeatedly read the wireless sensors 405 and re-group the wireless sensors 405 receiving battery pack information from the same battery pack 104 together thereby updating the location and status of the battery packs 104 in real-time. The charger controller 122 may repeatedly read the wireless sensors 405 and re-group the wireless sensors 405 receiving battery pack information from the same battery pack 104 for all battery packs 104 on the wireless charging mat 102. Accordingly, the location and status of all battery packs 104 on the wireless charging mat 102 may be updated in real time.

At block 630, the charger controller 122 controls the visual indicators 410 that correspond to each group to illuminate in the same manner based on the battery pack information received from the battery pack 104, thereby visually indicating battery pack information about the battery packs 104 using the wireless charging mat 102. Accordingly, the charger controller 122 may detect movement, in real time, of a battery pack 104 from a first location to a second location on the wireless charging mat 102. The charger controller 122 may also update the output of the array of visual indicators 410 at the second location in real time to visually indicate battery pack information of the battery pack 104 that has been moved.

At block 635, the wireless charging mat 102 stops charging those battery packs 104 determined to be fully charged based on the battery pack information received by the wireless sensors 405. For instance, the charger controller 122 controls each coil driver 124 associated with a fully charged battery pack 104 to stop driving the associated charging coil 126. At block 640, the wireless charging mat 102 continues to charge the battery packs 104 that are not fully charged, as determined by the battery pack information received by the wireless sensors 405. The method 600 then proceeds to block 705 (see FIG. 7). At block 620, when no battery packs 104 have moved to a different location on the wireless charging mat 102, the method 600 proceeds to block 705 (see FIG. 7).

FIG. 7 illustrates a method 700 of displaying battery pack information on the wireless charging mat 102 when an added battery pack 104 is newly placed on the wireless charging mat 102. At block 705, the charger controller 122 determines whether an added battery pack 104 is newly present on the wireless charging mat 102. When an added battery pack 104 is not newly present, the method 700 proceeds to block 730. When at least one wireless sensor 405 detects the added battery pack 104, at block 710, the charger controller 122 obtains battery pack information from each wireless sensor 405 within range of the added battery pack 104. At block 715, the charger controller 122 creates a new group of wireless sensors 405 and visual indicators 410 that correspond to the wireless sensors 405 within range of the battery pack 104. At block 720, the charger controller 122 controls the output of the visual indicators 410 of the new group to illuminate in the same manner based on the battery pack information received from the added battery pack 104.

At block 725, the wireless charging mat 102 determines whether the added battery pack 104 is fully charged. When the added battery pack 104 is fully charged, the wireless charging mat 102 does not begin charging the added battery pack 104 and proceeds to block 730. When the added battery pack 104 is not fully charged, the wireless charging mat 102 begins charging the added battery pack 104 at block 735 and then proceeds to block 730.

At block 730, the wireless charging mat 102 stops charging those battery packs 104 determined to be fully charged based on the battery pack information received by the wireless sensors 405. At block 740, the wireless charging mat 102 continues to charge the battery packs 104 that are not fully charged, as determined by the battery pack information received by the wireless sensors 405. The method 700 then proceeds to block 605 (see FIG. 6) to repeat the method 600. Repeating the method illustrated by the flowcharts in FIGS. 5 through 7 allows the charger controller 122 to monitor the battery packs 104 placed on the wireless charging mat 102 and display battery pack information in real time on the visual indicators 410 located near each battery pack 104.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method of visually indicating battery pack information related to wirelessly charging a battery pack via a wireless charging mat, the method comprising:
uniquely associating, with a controller of the wireless charging mat, each visual indicator of a first plurality of visual indicators on the wireless charging mat with one of a first plurality of sensors on the wireless charging mat;
receiving the battery pack information from the battery pack with one or more of the first plurality of sensors;
wirelessly charging the battery pack using the wireless charging mat; and
illuminating the first plurality of visual indicators based on the battery pack information.

2. The method of claim 1, wherein illuminating the first plurality of visual indicators based on the battery pack information includes illuminating the first plurality of visual indicators in a pattern that substantially outlines a predetermined shape of the battery pack.

3. The method of claim 1, wherein illuminating the first plurality of visual indicators includes at least one selected from the group consisting of
illuminating the first plurality of visual indicators to illuminate a color,
illuminating the first plurality of visual indicators to intermittently illuminate, and
changing the color emitted by the first plurality of visual indicators.

4. The method of claim 1, wherein receiving the battery pack information includes receiving the battery pack information including at least one selected from the group consisting of a battery type, a charging status of the battery pack, or an owner identifier of the battery pack.

5. The method of claim 1, further comprising illuminating a second plurality of visual indicators based on each visual indicator of the second plurality of visual indicators being located within a predetermined distance from the first plurality of sensors.

6. The method of claim 1, further comprising:
detecting movement of the battery pack from a first location on the wireless charging mat to a second location on the wireless charging mat;
uniquely associating, with the controller of the wireless charging mat, each visual indicator of a second plurality of visual indicators on the wireless charging mat with one of a second plurality of sensors on the wireless charging mat associated with the second location;
receiving the battery pack information from the battery pack with one or more of the second plurality of sensors; and
illuminating the second plurality of visual indicators based on the battery pack information.

7. The method of claim 1, wherein receiving the battery pack information from the battery pack with one or more of the first plurality of sensors includes periodically receiving an updated charge status of the battery pack.

8. The method of claim 1, wherein wirelessly charging the battery pack using the wireless charging mat includes wirelessly charging the battery pack using the wireless charging mat when the battery pack is coupled to a battery powered device.

9. The method of claim 1, further comprising:
receiving, with one or more of the first plurality of sensors, an owner identifier of the battery pack; and
illuminating the first plurality of visual indicators to illuminate a color based on the owner identifier.

10. The method of claim 1, further comprising locating a second wireless charging mat substantially parallel to the wireless charging mat;
uniquely associating, with a second controller of the second wireless charging mat, each visual indicator of a second plurality of visual indicators on the second wireless charging mat with one of a second plurality of sensors on the second wireless charging mat;
receiving the battery pack information from the battery pack with one or more of the second plurality of sensors;
wirelessly charging, the battery pack using the second wireless charging mat; and
illuminating the second plurality of visual indicators based on the battery pack information.

11. A system for visually indicating battery pack information related to wirelessly charging a battery pack, the system comprising:
a wireless charging mat including
a power supply,
a plurality of charging coils, each of the plurality of charging coils coupled to the power supply and configured to wirelessly charge the battery pack using power received via the power supply,
a first plurality of sensors, each of the first plurality of sensors configured to receive the battery pack information from the battery pack,
a first plurality of visual indicators, wherein each of the first plurality of visual indicators is uniquely associated with one of the first plurality of sensors; and
a controller that illuminates the first plurality of visual indicators based on the battery pack information.

12. The system of claim 11, wherein the controller illuminates the first plurality of visual indicators in a pattern that substantially outlines a predetermined shape of the battery pack.

13. The system of claim 11, wherein the controller performs at least one selected from the consisting of
illuminating the first plurality of visual indicators to illuminate a color,
illuminating the first plurality of visual indicators to intermittently illuminate, and
changing the color emitted by the first plurality of visual indicators.

14. The system of claim 11, wherein the battery pack information includes at least one selected from the group consisting of a battery type, a charging status of the battery pack, or an owner identifier of the battery pack.

15. The system of claim 11, further comprising a second plurality of visual indicators, wherein the second plurality of visual indicators is illuminated based on each visual indicator of the second plurality of visual indicators being located within a predetermined distance from the first plurality of sensors.

16. The system of claim 11, further comprising:
a second plurality of sensors associated with a second location on the wireless charging mat; and
a second plurality of visual indicators, wherein each visual indicator of the second plurality of visual indicators is uniquely associated with one of the second plurality of sensors;
wherein the controller
detects movement of the battery pack from a first location on the wireless charging mat to the second location on the wireless charging mat,
receives the battery pack information from the battery pack via one or more of the second plurality of sensors, and
illuminates the second plurality of visual indicators based on the battery pack information.

17. The system of claim 11, wherein the controller periodically receives an updated charge status of the battery pack.

18. The system of claim 11, wherein the battery pack is coupled to a battery powered device.

19. The system of claim 11, wherein the controller receives an owner identifier of the battery pack and illuminates the first plurality of visual indicators to illuminate a color based on the owner identifier.

20. The system of claim 11, further comprising
a second wireless charging mat located substantially parallel to the wireless charging mat, the second wireless charging mat including;
a second plurality of sensors, each of the second plurality of sensors configured to receive the battery pack information from the battery pack;
a second plurality of visual indicators, wherein each of the second plurality of visual indicators is uniquely associated with one of the second plurality of sensors; and
a second controller that illuminates the second plurality of visual indicators based on the battery pack information.
